(19) United States
(12) Patent Application Publication
(10) Pub. No.: US 2017/0043790 A1
(43) Pub. Date: Feb. 16, 2017

(54) MOVEMENT ASSISTANCE APPARATUS, MOVEMENT ASSISTANCE METHOD, AND DRIVING ASSISTANCE SYSTEM BASED ON THE DISPLAY OF THE DRIVING MODES ACCORDING THE DIFFERENT SECTIONS OF THE TRAVEL IN THE RANGE ALLOWED BY THE STATE OF CHARGE OF THE BATTERY

(71) Applicant: TOYOTA JIDOSHA KABUSHIKI KAISHA, Toyota-shi, Aichi-ken (JP)

(72) Inventor: Keisuke MORISAKI, Toyota-shi (JP)

(73) Assignee: TOYOTA JIDOSHA KABUSHIKI KAISHA, Toyota-shi, Aichi-ken (JP)

(21) Appl. No.: 15/305,388

(22) PCT Filed: Apr. 13, 2015
(86) PCT No.: PCT/IB2015/000475

§ 371 Date: Oct. 20, 2016

(30) Foreign Application Priority Data
Apr. 25, 2014 (JP) 2014-091591

(51) Int. Cl. B60W 50/14; B60W 20/12; B60W 50/00; B60W 10/06; B60W 10/08

(52) U.S. Cl. CPC B60W 50/14; B60W 10/06; B60W 10/08; B60W 50/0097; B60W 20/12; B60W 2050/146; B60W 2510/244; B60W 2550/402; Y10S 903/904

(57) ABSTRACT

A movement assistance apparatus that assists movement of a vehicle having an internal combustion engine and a motor as drive sources from a departure place to a destination includes: a planning unit that plans one of a first travel mode and a second travel mode in relation to respective sections marked out on a travel route from the departure place to the destination; a predicted distance calculation unit that calculates a predicted distance over which the vehicle can travel in the first travel mode from the amount of power stored in the battery; and a display unit that displays set travel modes from a current location up to a point on the travel route located a predetermined distance ahead of the current location, wherein the display unit displays the predicted distance, and determines the predetermined distance to be displayed on the basis of the predicted distance.

### BACKGROUND OF THE INVENTION

1. Field of the Invention

The invention relates to a movement assistance apparatus, a movement assistance method, and a driving assistance system with which to manage the application of a plurality of travel modes to a vehicle.

2. Description of Related Art

A hybrid vehicle that uses an internal combustion engine and a motor as drive sources is available as a vehicle having a plurality of travel modes, such as that described above. The hybrid vehicle includes, as the plurality of travel modes, a first mode (an electric vehicle (EV) mode) in which EV travel, i.e. travel using only the motor while the internal combustion engine is stopped, is prioritized so that an amount of power stored in a battery is not maintained, a second mode (a hybrid vehicle (HV) mode) in which HV travel, i.e. travel using both the internal combustion engine and the motor, is prioritized so that the amount of power stored in the battery is maintained, and so on. Further, a movement assistance apparatus that is installed in the hybrid vehicle and includes a navigation system and so on provides assistance such as calculating a travel route from a current location to a destination on the basis of map information, road traffic information, and so on, and selecting the travel mode to be applied in each of a plurality of sections marked out on the travel route. Japanese Patent Application Publication No. 2009-12605 (JP 2009-12605 A), for example, describes an example of a vehicle control apparatus having this type of movement assistance function.

Incidentally, in the vehicle control apparatus described in JP 2009-12605 A, the travel mode applied to each section of the travel route is set in consideration of an overall energy balance of the travel route so that a remaining charge of a battery constituted by a secondary battery reaches zero at the destination. A vehicle may also include a display apparatus that displays the travel modes set in this manner in the respective sections of the travel route so that the travel modes can be seen by a driver. However, information displayed by the display apparatus is information corresponding to the remaining charge of the battery at a given time, and this information may diverge in particular from information indicating a distance that can be traveled in the first mode. As a result of this divergence, the driver may experience a sense of discomfort.

Note that this problem is more or less shared by all apparatuses and methods for allocating travel modes to a vehicle that includes a plurality of travel modes having different energy balances.

### SUMMARY OF THE INVENTION

The invention provides a movement assistance apparatus, a movement assistance method, and a driving assistance system with which a sense of discomfort experienced by a driver when a travel mode plan is displayed can be suppressed.

A first aspect of the invention relates to a movement assistance apparatus that assists movement of a vehicle having an internal combustion engine and a motor as drive sources from a departure place to a destination. The movement assistance apparatus includes: a planning unit that plans one of a first travel mode in which an amount of power stored in a battery is not maintained and a second travel mode in which the amount of power stored in the battery is maintained in relation to respective sections marked out on a travel route from the departure place to the destination; a predicted distance calculation unit that calculates a predicted distance over which the vehicle can travel in the first travel mode, from the amount of power stored in the battery; and a display unit that displays set travel modes from a current location up to a point on the travel route located a predetermined distance ahead of the current location, wherein the display unit displays the predicted distance, and determines the predetermined distance to be displayed on the basis of the predicted distance.

A second aspect of the invention relates to a movement assistance method for assisting movement of a vehicle having an internal combustion engine and a motor as drive sources from a departure place to a destination. The movement assistance method includes: causing a planning unit to plan one of a first travel mode in which an amount of power stored in a battery is not maintained and a second travel mode in which the amount of power stored in the battery is maintained in relation to respective sections marked out on a travel route from the departure place to the destination; causing a predicted distance calculation unit to calculate a predicted distance over which the vehicle can travel in the first travel mode, from the amount of power stored in the battery; and causing a display unit to display the planned travel modes from a current location up to a point on the travel route located a predetermined distance ahead of the current location, wherein the display unit displays the predicted distance, and determines the predetermined distance to be displayed on the basis of the predicted distance.

Normally, the first travel mode and the second travel mode, of the planned travel modes, are allocated in consideration of an overall energy balance of the travel route from the departure place to the destination, and a subsequent regenerative current (power) or the like, for example, is not reflected in the amount of power stored in the battery at a given time. It is therefore difficult to avoid divergence between distance information obtained from the amount of power stored in the battery at a given time and distance information obtained from the planned travel modes. This divergence in the distance information becomes particularly striking for the distance over which the vehicle can travel in the first travel mode. Therefore, in the configuration or the method described above, the predicted distance over which the vehicle can travel in the first travel mode is determined from the amount of power stored in the battery at a given time, and the predetermined distance to be displayed is determined on the basis of the determined predicted distance. In so doing, the divergence in the distance information can be apparently reduced by modifying a display range or a display scale of the travel modes, and as a result, a sense of discomfort experienced by a driver when a travel mode plan is displayed can be suppressed.

In the first aspect, the display unit may determine the predetermined distance to be displayed such that a total distance of sections in which the first travel mode is planned, from among sections from the current location up to the point located the predetermined distance ahead of the current location, does not exceed an upper limit value set on the basis of the predicted distance.

In the second aspect, the display unit may determine the predetermined distance to be displayed such that a total distance of sections in which the first travel mode is planned, from among sections from the current location up to the point located the predetermined distance ahead of the current location, does not exceed an upper limit value set on the basis of the predicted distance.

As described above, a subsequent regenerative current (power) or the like is not reflected in the amount of power stored in the battery at a given time, and therefore the predicted distance tends to be shorter than the distance for which the first travel mode is planned. Hence, according to the configuration or the method described above, in which the divergence is compensated for by providing the upper limit value, the reliability of the predetermined distance determined as described above can be improved.

In the first aspect, the display unit may display the travel modes planned by the planning unit within a range extending from the current location to the point located the predetermined distance ahead of the current location, from a display range in which the travel modes are displayed.

In the second aspect, the display unit may display the travel modes planned by the planning unit within a range extending from the current location to the point located the predetermined distance ahead of the current location, from a display range in which the travel modes are displayed.

In the first aspect, the display unit may display the travel modes planned by the planning unit after aligning a display range in which the travel modes are to be displayed with a range extending from the current location to the point located the predetermined distance ahead of the current location.

In the second aspect, the display unit may display the travel modes planned by the planning unit after aligning a display range in which the travel modes are to be displayed with a range extending from the current location to the point located the predetermined distance ahead of the current location.

A third aspect of the invention relates to a driving assistance system that assists driving of a vehicle having an internal combustion engine and a motor as drive sources on the basis of one travel mode selected from a plurality of different travel modes that are planned in respective sections marked out on a travel route of the vehicle from a departure place to a destination. The driving assistance system includes the movement assistance apparatus according to the first aspect, which plans and displays one travel mode selected from the plurality of travel modes in each section of the travel route.

According to the configurations described above, a sense of discomfort experienced by a driver when a travel mode plan is displayed can be suppressed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic block diagram showing a configuration of a first embodiment of a movement assistance apparatus;

FIG. 2 is a flowchart showing processing procedures of travel mode planning processing performed by the movement assistance apparatus according to this embodiment;

FIG. 3 is a flowchart showing processing procedures of travel mode display processing performed by the movement assistance apparatus according to this embodiment;

FIG. 4 is a view showing an example of travel modes in respective sections of a travel route, planned by the movement assistance apparatus according to this embodiment;

FIG. 5A is a view showing an example of a display of the planned travel modes;

FIG. 5B is a view showing an example of a display of travel modes displayed by the movement assistance apparatus according to this embodiment;

FIG. 6 is a view showing a modified example of a display of travel modes displayed by the movement assistance apparatus; and

FIG. 7 is a schematic block diagram showing a configuration of a modified example of the movement assistance apparatus.

### DETAILED DESCRIPTION OF EMBODIMENTS

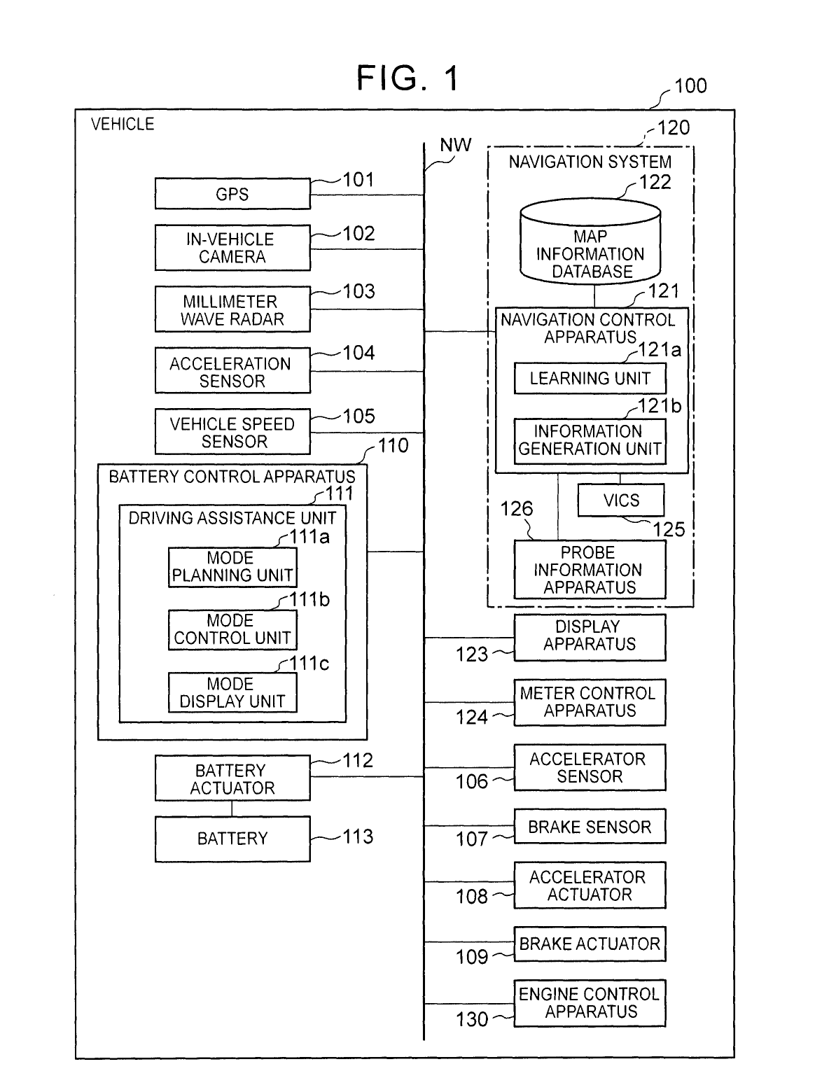

A specific embodiment of a movement assistance apparatus, a movement assistance method, and a driving assistance system will be described below with reference to FIGS. 1 to 5B. Note that the movement assistance apparatus, movement assistance method, and driving assistance system according to this embodiment are applied to a hybrid vehicle including, as respective drive sources, an electric motor that uses a battery constituted by a secondary battery as a power source and an internal combustion engine that uses gasoline or another type of fuel as a power source.

As shown in FIG. 1, a global positioning system (GPS) 101, an in-vehicle camera 102, a millimeter wave radar 103, an acceleration sensor 104, a vehicle speed sensor 105, and so on, for example, are installed in a vehicle 100 as apparatuses that detect travel conditions of the vehicle 100. The GPS 101, the in-vehicle camera 102, the millimeter wave radar 103, the acceleration sensor 104, and the vehicle speed sensor 105 are connected to a hybrid control apparatus 110, a navigation control apparatus 121 of a navigation system 120, and an engine control apparatus 130 via an in-vehicle network NW such as a controller area network (CAN), for example. Further, the hybrid control apparatus 110, the navigation control apparatus 121, and the engine control apparatus 130 are each configured to include a so-called electronic control unit (ECU), which is a microcomputer having a calculation apparatus and a storage apparatus. The hybrid control apparatus 110, the navigation control apparatus 121, and the engine control apparatus 130 are capable of performing various types of control using programs stored in the storage apparatuses and parameters calculated by the calculation apparatuses.

The GPS 101 receives a signal from a GPS satellite, and detects a position of the vehicle 100 on the basis of the signal received from the GPS satellite in the form of latitude/longitude, for example. Further, the GPS 101 outputs position information, which is information indicating the detected position (latitude/longitude) of the vehicle 100. The in-vehicle camera 102 photographs a peripheral environment of the vehicle 100, and outputs photographed image data. The millimeter wave radar 103 detects objects existing on the periphery of the vehicle 100 using millimeter band radio waves, and outputs a signal corresponding to a detection result.

The acceleration sensor 104 detects an acceleration of the vehicle 100, and outputs a signal corresponding to the detected acceleration. The vehicle speed sensor 105 detects a rotation speed of a vehicle wheel of the vehicle 100, and outputs a signal corresponding to the detected rotation speed.

An accelerator sensor 106 detects an amount by which an accelerator pedal is operated by a driver, and outputs a signal corresponding to the detected accelerator pedal operation amount. A brake sensor 107 detects an amount by which a brake pedal is operated by the driver, and outputs a signal corresponding to the detected brake pedal operation amount.

The vehicle 100 is further provided with an accelerator actuator 108 that controls a driving condition of the internal combustion engine, and a brake actuator 109 that controls a brake. The accelerator actuator 108 and the brake actuator 109 are electrically connected to the in-vehicle network NW. The accelerator actuator 108 controls the internal combustion engine on the basis of an internal combustion engine control amount calculated by the engine control apparatus 130 in accordance with a detection value from the accelerator sensor 106. Further, the brake actuator 109 controls the brake on the basis of a brake control amount calculated by the engine control apparatus 130 in accordance with a detection value from the brake sensor 107.

The vehicle 100 is further provided with a battery 113 that serves as the power source of the electric motor serving as a drive source, and a battery actuator 112 that controls charging and discharging of the battery 113. The battery actuator 112 is electrically connected to the in-vehicle network NW. The battery actuator 112 manages charging and discharging of the battery 113 and so on. The battery actuator 112 also drives the electric motor by controlling charging and discharging of the battery 113, and charges the battery 113 by regenerating the electric motor.

The hybrid control apparatus 110 is provided in the vehicle 100 to control driving conditions of the internal combustion engine and the electric motor. The hybrid control apparatus 110 is electrically connected to the battery actuator 112, the accelerator actuator 108, and the brake actuator 109 via the in-vehicle network NW.

The hybrid control apparatus 110 determines allocations (an output ratio) of driving force to the internal combustion engine and the electric motor on the basis of detection results from the acceleration sensor 104, the vehicle speed sensor 105, and the accelerator sensor 106. In particular, the hybrid control apparatus 110 adjusts a remaining charge of the battery 113, i.e. a remaining amount of energy in the battery 113, by modifying the allocations (the output ratio) of the driving force distributed to the internal combustion engine and the electric motor. The hybrid control apparatus 110 executes EV travel, in which the internal combustion engine is stopped and the electric motor is used as a drive source, and HV travel, in which the internal combustion engine and the electric motor are both used as drive sources.

The hybrid control apparatus 110 selects, as appropriate, a charge depleting (CD) mode, which is a mode in which an amount of power stored in the battery 113 is consumed, and a charge sustaining (CS) mode, which is a mode in which the amount of power stored in the battery 113 is maintained.

The CD mode is a mode in which the amount of power stored in the battery 113 is not maintained, i.e. power charged to the battery 113 is actively consumed, and a mode in which EV travel is prioritized. Hereafter, the CD mode will be described as an EV mode. Note that even in the EV mode, when the accelerator pedal is depressed by a large amount such that a large amount of travel power is required, the internal combustion engine is driven.

The CS mode is a mode in which the amount of power stored in the battery 113 is maintained within a predetermined range of a reference value, and a mode in which HV travel is prioritized by driving the internal combustion engine and performing a regeneration operation on the electric motor in accordance with the need to maintain the amount of stored power. Hereafter, the CS mode will be described as an HV mode. Note that even in the HV mode, when the amount of power stored in the battery 113 exceeds the reference value, the internal combustion engine is stopped. A value of the amount of stored power when the EV mode is switched to the HV mode, or a value of the amount of stored power required to maintain the functions of the battery 113, is set appropriately as the reference value of the HV mode.

The hybrid control apparatus 110 generates a control command to be issued to the battery actuator 112 in relation to charging and discharging of the battery 113 or the like and information relating to the internal combustion engine control amount to be calculated by the engine control apparatus 130 on the basis of the driving force allocations in the selected EV mode or HV mode. Further, the hybrid control apparatus 110 determines driving force allocations of the brake and the electric motor on the basis of the detection results obtained by the acceleration sensor 104, the vehicle speed sensor 105, and the brake sensor 107. The hybrid control apparatus 110 then generates a control command to be issued to the battery actuator 112 in relation to charging and discharging of the battery 113 or the like and information relating to the brake control amount to be calculated by the engine control apparatus 130 on the basis of the driving force allocations. In other words, the hybrid control apparatus 110 controls charging and discharging of the battery 113 by outputting the generated control command to the battery actuator 112. As a result, the electric motor that uses the battery 113 as a power source (an electric power source) is driven by discharging the battery 113, and the battery 113 is charged by regenerating the electric motor. The hybrid control apparatus 110 is also capable of monitoring execution conditions of the hybrid control and a state of charge of the battery 113.

The hybrid control apparatus 110 performs control to switch between the EV mode and the HV mode in response to a selection result from the driver of the vehicle 100. Further, the hybrid control apparatus 110 has a function for switching between the EV mode and the HV mode automatically, and performs control to switch between the EV mode and the HV mode on the basis of information relating to a travel load required to travel through respective sections of a travel route of the vehicle 100, which is input from the navigation control apparatus 121, and so on. Note that the travel load is a load per unit distance within the corresponding section, and an average load required to travel through the section. A cumulative value of the travel load required to travel through the entire section, meanwhile, is defined as an energy consumption.

The vehicle 100 further includes a map information database 122 in which map data are registered. The map data are data relating to geographical features such as roads. Position-related information such as latitudes and longitudes is registered in the map data together with display type data enabling the display of geographical features and the like. The display type data include display information relating to rivers, lakes, seas, and so on. Information relating to intersection names, road names, area names, direction guides, facility information, and so on may also be registered in the map data.

Furthermore, node data, which are constituted by information relating to nodes indicating positions on a road, and link data, which are constituted by information relating to a link serving as a section between two nodes, are included in the map information database 122. The nodes are set in positions of specific traffic elements on the road, such as intersections, traffic lights, and curbs, points where a number of lanes changes, and so on. The node data include node position information, road information in the corresponding position, and so on. A link is set between two nodes as a section defined by the two nodes. The link data include information relating to the two nodes, road information relating to the section serving as the link, and so on. The travel load can be obtained or calculated from travel load information included in the link data. The road information in the section serving as the link includes information indicating a start point position, an end point position, a distance, a route, an undulation, and so on. The link data include various other data such as mark data indicating a specific position, intersection data indicating intersection information, and facility data indicating facility information.

More specifically, the node data may be constituted by, for example, node IDs serving as node identification numbers, node coordinates, link IDs for all of the links connected to the nodes, node types indicating types of nodes such as intersections and merging locations, and so on. The node data may also be constituted by data indicating node characteristics such as image IDs, which are identification numbers of images representing the nodes, and so on.

Further, the link data are constituted by link IDs serving as link identification numbers, link lengths, and the node IDs of the nodes connected respectively to the start points and end points of the links, for example. The link data are also constituted by required information selected from data indicating road types such as expressways, toll roads, general roads, urban/suburban roads, mountain roads, tunnels, bridges, and cloverleaf intersections, data indicating road widths, numbers of lanes, link travel times, legal speed limits, road gradients, and so on. The link data may also be constituted by data indicating average values, maximum values, and minimum values of a movement time, a movement speed, a fuel consumption, a power consumption, and so on as travel load information indicating an output required of the vehicle 100 in each link. The power consumption is an amount of power consumed by the electric motor when the vehicle 100 travels in the EV mode. The travel load of a link (section) is obtained or calculated on the basis of the travel load information. Note that the travel load is an average value within a link (section), and uses [kW] or the like as a unit. Further, the energy consumption, i.e. the cumulative value of the travel load required to travel through an entire link (section), can be calculated from the travel load and the link length (section length).

The navigation system 120 is installed in the vehicle 100 to perform route guidance and the like. The navigation control apparatus 121 of the navigation system 120 obtains a current location (latitude/longitude) of the vehicle 100 from the GPS 101. Further, when a target location is set by the driver, the navigation control apparatus 121 specifies the target location (latitude/longitude). The navigation control apparatus 121 then retrieves a travel route from the current location of the vehicle 100 to the target location by referring to the map information database 122 using Dijkstra's algorithm or the like, for example. Note that the current location corresponds to the departure place in this specific embodiment.

The navigation control apparatus 121 includes a learning unit 121a that learns the movement time, movement speed, fuel consumption, and power consumption of the vehicle 100 while traveling along the travel route. The learning unit 121a constitutes a part of the movement assistance apparatus, and the functions thereof are realized by executing processing of a program stored in the navigation control apparatus 121 and so on. The learning unit 121a obtains the movement time, movement speed, fuel consumption, and power consumption of each section on the travel route from the various sensors, and stores the obtained information in association with the respective sections in the map information database 122. The learning unit 121a accumulates the information in association with the respective sections in the map information database 122 every time the vehicle 100 travels through the same sections, thereby improving the precision of the information relating to each section.

The navigation control apparatus 121 also includes an information generation unit 121b that generates information such as the travel load that is referred to when creating a travel mode plan. The information generation unit 121b constitutes a part of the movement assistance apparatus, and the functions thereof are realized by executing processing of a program stored in the navigation control apparatus 121 and so on. In particular, the information generation unit 121b has a function for calculating the travel load of each section of the travel route on the basis of gradient information and congestion information relating to each section. The information generation unit 121b calculates the travel load during normal travel on the basis of vehicle information such as the movement speed, movement time, fuel consumption, and power consumption of the vehicle 100, and information relating to the travel environment. The learning unit 121a stores the calculated travel load in association with each section in the map information database 122.

A vehicle information and communication system (VICS (registered trademark)) 125 that obtains information such as congestion information, a required time, accident, breakdown, and roadwork information, speed restrictions, and lane restrictions is connected to the navigation control apparatus 121. Further, a probe information apparatus 126 that obtains probe traffic information, which is road traffic information generated using information such as actual travel positions and vehicle speeds obtained from a data center or a vehicle that shares information, is connected to the navigation control apparatus 121. By obtaining congestion information from one or both of the VICS 125 and the probe information apparatus 126, the information generation unit 121b can learn which of the sections of the travel route are congested.

The navigation control apparatus 121 outputs information indicating the retrieved travel route, the calculated travel load, the movement time, the movement speed, the fuel consumption, and the power consumption to the hybrid control apparatus 110 via the in-vehicle network NW, and outputs this information to the display apparatus 123, which is constituted by a liquid crystal display or the like provided in a vehicle cabin, via the in-vehicle network NW.

The vehicle 100 is further provided with a meter control apparatus 124 that controls displayed conditions displayed on a meter of an instrument panel provided on a dashboard. The meter control apparatus 124 obtains data indicating a charging/discharging condition of the battery 113 and so on, for example, from the hybrid control apparatus 110, and displays an internal energy flow of the vehicle 100 visibly, for example, on the basis of the obtained data. The energy flow is a flow of energy through the vehicle 100 generated by charging and discharging the battery 113, driving and regenerating the electric motor, and so on. Note that a flow of energy through the vehicle 100 generated by driving the internal combustion engine and so on may also be included in the energy flow.

When a travel route is input into the hybrid control apparatus 110, the hybrid control apparatus 110 allocates a travel mode to each section of the travel route. The hybrid control apparatus 110 includes a driving assistance unit 111 that assists travel mode allocation in accordance with the travel route. The driving assistance unit 111 obtains information relating to the travel route to the target location set by the driver from the navigation control apparatus 121. Further, the driving assistance unit 111 includes a mode planning unit 111a that plans the travel modes to be allocated to the respective sections of the obtained travel route and so on. The mode planning unit 111a constitutes a part of the movement assistance apparatus, and the functions thereof are realized by executing processing of a program stored in the hybrid control apparatus 110 and so on. The mode planning unit 111a has a function for planning the travel mode of each section of the travel route in accordance with the travel load of each section, taking into consideration the overall energy balance of the travel route.

Typically, greater efficiency tends to be obtained when travel using the electric motor is applied to a section having a smaller travel load and travel using the internal combustion engine is applied to a section having a larger travel load. Therefore, the hybrid control apparatus 110 allocates the EV mode to sections having a small travel load, and allocates the HV mode to sections having a large travel load.

The mode planning unit 111a compares the travel loads of a plurality of subject sections, and allocates the EV mode in order from the section having the smallest travel load. Further, the mode planning unit 111a integrates the energy consumption of the sections allocated the EV mode, and subtracts the integrated energy consumption from a remaining amount of energy in the battery 113. The mode planning unit 111a then continues to allocate the EV mode to the respective sections while ensuring that the integrated energy consumption does not exceed the remaining amount of energy in the battery 113. The mode planning unit 111a thus allocates the EV mode to the sections having a relatively small travel load, among the respective sections of the travel route. Further, the mode planning unit 111a allocates the HV mode to the sections to which the EV mode is not allocated.

The driving assistance unit 111 further includes a mode control unit 111b that causes the vehicle 100 to travel in the travel modes planned by the mode planning unit 111a. The mode control unit 111b constitutes a part of the movement assistance apparatus, and the functions thereof are realized by executing processing of a program stored in the hybrid control apparatus 110 and so on. The mode control unit 111b specifies a current travel section, or in other words a current section, by obtaining information indicating a current travel position as appropriate, and switches to the mode, from the EV mode and the HV mode, that has been allocated to the specified section.

The driving assistance unit 111 further includes a mode display unit 111c that displays the travel modes planned by the mode planning unit 111a and the travel mode controlled by the mode control unit 111b. The mode display unit 111c constitutes a part of the movement assistance apparatus, and the functions thereof are realized by executing processing of a program stored in the hybrid control apparatus 110 and so on. The mode display unit 111c outputs the travel mode to the display apparatus 123 and the meter control apparatus 124 in relation to each section of the travel route so that the travel modes of the traveled sections are displayed on the display apparatus 123 and the meter. In other words, as shown in FIG. 5A, the planned travel modes are displayed on the display apparatus 123 and the meter from the current location up to a point located a predetermined distance ahead, for example 10 km ahead, of the current location. The mode display unit 111c also causes the display apparatus 123 and the meter to display an EV range in which travel is possible in the EV mode on the basis of the current amount of power stored in the battery 113 (the remaining charge of the battery 113). The EV range is a distance that can be traveled at an average travel load, and tends to be shorter than an actual travel distance obtained when driving assistance is performed so as to allocate the EV mode preferentially to sections having a small travel load.

Incidentally, the mode planning unit 111a plans the travel modes of the respective sections of the travel route in consideration of the overall energy balance of the travel route so that the remaining charge of the battery 113 reaches zero at the destination. However, the information displayed on the display apparatus 123 and the meter may diverge from information corresponding to the remaining charge of the battery 113 at a given time, particularly information indicating the distance that can be traveled in the EV mode, and as a result, the driver may experience discomfort. Hence, the mode display unit 111c varies the predetermined distance displayed as described above in accordance with the remaining charge of the battery 113 at a given time. In other words, the mode display unit 111c modifies a display range or a display scale in which the planned travel modes are displayed by modifying the predetermined distance within the range extending to the predetermined distance from the current location, in which the planned travel modes are displayed.

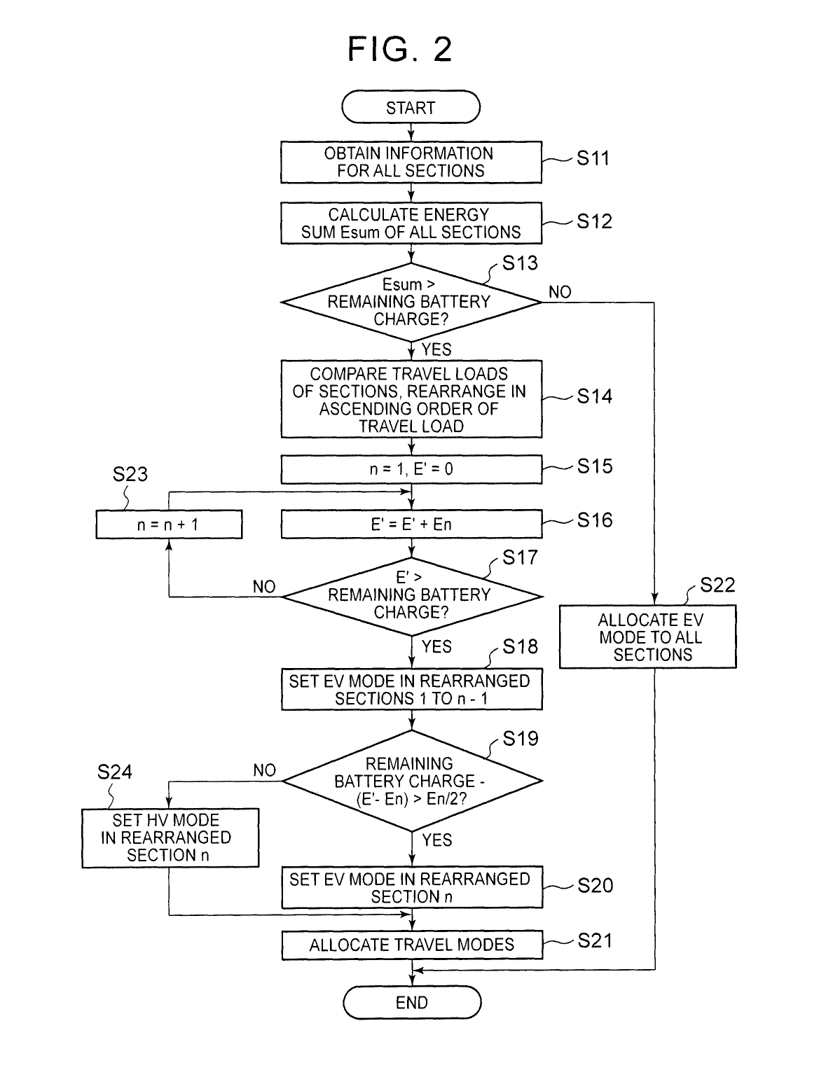

Next, referring to FIG. 2, travel mode planning processing executed by the mode planning unit 111a of the driving assistance unit 111 will be described together with actions thereof. The driving assistance unit 111 plans the travel modes in relation to the respective sections of the travel route every time a travel route is transmitted thereto from the navigation control apparatus 121. When a target location is set by the navigation control apparatus 121, the driving assistance unit 111 obtains route information in relation to all sections of the travel route (step S11).

Next, the driving assistance unit 111 calculates a sum Esum of the energy consumption in all sections of the travel route (step S12), and determines whether or not the sum Esum of the energy consumption in all sections of the travel route exceeds the remaining charge of the battery 113 (step S13). In other words, the mode planning unit 111a determines whether or not it is possible to travel through all sections of the travel route in the EV mode. When it is determined that the sum Esum of the energy consumption in all sections of the travel route does not exceed the remaining charge of the battery 113 (step S13: NO), the driving assistance unit 111 allocates the EV mode to all sections of the travel route (step S22).

When it is determined that the sum Esum of the energy consumption in all sections of the travel route exceeds the remaining charge of the battery 113 (step S13: YES), on the other hand, the driving assistance unit 111 compares the travel loads of the respective sections of the travel route, and rearranges the respective sections in ascending order of the travel load (step S14).

The driving assistance unit 111 sets the sections rearranged in ascending order of the travel load as sections n=1 to n, and sets the section n at n=1 and an energy consumption E′ at E′=0 (step S15). The driving assistance unit 111 then calculates a sum (E′=E′+En) of the energy consumption up to the section n (step S16). Note that the energy consumption of the current travel section is calculated on the basis of the travel load obtained from the map information database 122.

Next, the driving assistance unit 111 determines whether or not the sum E′ of the energy consumption of the sections up to the section n exceeds the remaining charge of the battery 113 (step S17). When it is determined that the sum E′ of the energy consumption of the sections up to the section n does not exceed the remaining charge of the battery 113 (step S17: NO), the driving assistance unit 111 sets “n=n+1” in order to add a section (step S23).

When it is determined that the sum E′ of the energy consumption of the sections up to the section n exceeds the remaining charge of the battery 113 (step S17: YES), on the other hand, the driving assistance unit 111 allocates the EV mode to the rearranged sections 1 to n−1 (step S18). Further, the driving assistance unit 111 determines whether or not a difference between the remaining charge of the battery and a sum (E′−En) of the energy consumption up to the section n−1 is greater than half the energy consumption En of the rearranged section n (step S19). In other words, the mode planning unit 111a determines whether or not at least half the distance of the rearranged section n can be traveled in the EV mode.

When it is determined that the difference between the remaining charge of the battery and the sum (E′−En) of the energy consumption up to the section n−1 is not greater than half the energy consumption En of the rearranged section n (step S19: NO), the driving assistance unit 111 allocates the HV mode to the rearranged section n (step S24), and then advances to step S21. When it is determined that the difference between the remaining charge of the battery and the sum (E′−En) of the energy consumption up to the section n−1 is greater than half the energy consumption En of the rearranged section n (step S19: YES), on the other hand, the driving assistance unit 111 allocates the EV mode to the rearranged section n (step S20). After allocating travel modes to the respective sections of the travel route (step S21), the driving assistance unit 111 terminates the planning processing. In other words, the mode planning unit 111a allocates the HV mode to the sections in which the EV mode has not been set. The mode control unit 111b of the driving assistance unit 111 then performs travel mode control in relation to the respective sections of the travel route on the basis of the travel modes planned in the manner described above.

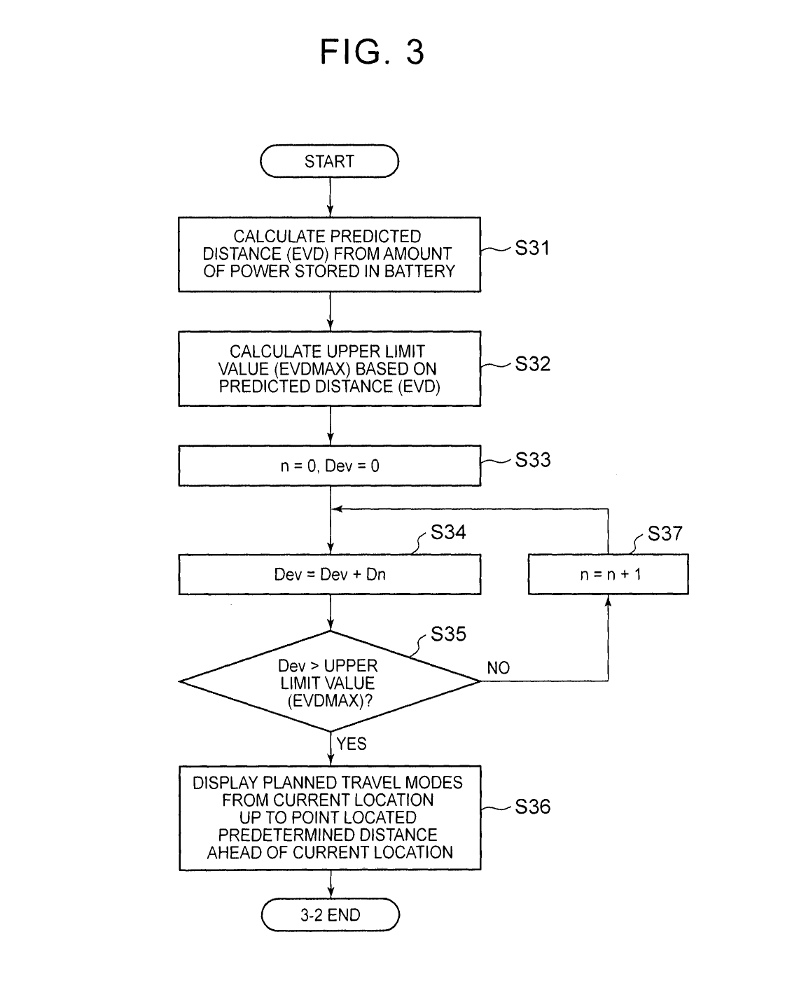

Next, referring to FIG. 3, travel mode display processing executed by the mode display unit 111c of the driving assistance unit 111 will be described together with actions thereof. The mode display unit 111c of the driving assistance unit 111 displays the travel modes allocated to the respective sections of the travel route on the basis of the travel modes planned by the mode planning unit 111a in relation to the respective sections of the travel route. Note that the mode display unit 111c also functions as a predicted distance calculation unit.

As shown in FIG. 3, when the vehicle 100 starts to travel, the driving assistance unit 111 calculates a predicted travelable distance (EVD) from the amount of power stored in the battery 113 (step S31). In other words, the mode display unit 111c calculates the distance that can be traveled using the current amount of power stored in the battery 113, assuming that travel is performed at the average travel load.

Next, the driving assistance unit 111 calculates an upper limit value (EVDMAX) on the basis of the calculated predicted distance (EVD) (step S32). In other words, as shown in Equation (1), the mode display unit 111c calculates the upper limit value (EVDMAX) by adding a margin α to the predicted distance (EVD).

EVDMAX=EVD+α (1)

The margin α takes a value determined in accordance with the amount of power stored in the battery 113 at a given time. During travel mode planning, the EV mode is set from the section having the smallest travel load, and therefore, depending on the current amount of power stored in the battery 113, the travelable distance may be longer than the predicted distance (EVD). Further, a difference between the predicted distance (EVD) and the actual traveled distance may be learned and reflected in the margin α.

The driving assistance unit 111 sets the sections in which the EV mode is planned as sections n=0 to n, sets the section n at n=0, and sets a section distance Dev at Dev=0 (step S33). The driving assistance unit 111 then calculates a sum (Dev=Dev+Dn) of the distances of the EV planned sections in which the EV mode is planned up to the EV planned section n (step S34). Note that the distances of the respective EV planned sections are obtained from the map information database 122.

Next, the driving assistance unit 111 determines whether or not the sum Dev of the distances of the EV planned sections up to the EV planned section n exceeds the upper limit value (EVDMAX) (step S35). When it is determined that the sum Dev of the distances of the EV planned sections up to the EV planned section n does not exceed the upper limit value (EVDMAX) (step S35: NO), the driving assistance unit 111 sets “n=n+1” in order to add a section (step S37).

When it is determined that the sum Dev of the distances of the EV planned sections up to the EV planned section n exceeds the upper limit value (EVDMAX) (step S35: YES), on the other hand, the driving assistance unit 111 displays the travel mode plan from the current location up to a point located a predetermined distance ahead of the current location (step S36). More specifically, the mode display unit 111c determines the EV planned section n in which the upper limit value (EVDMAX) is reached, or in other words the EV planned section n in which the amount of power stored in the battery 113 is used up, by adding the distances D (n−1) of the EV planned sections n one at a time from the section 0, and comparing the result with the upper limit value (EVDMAX). The mode display unit 111c then determines a point within the EV planned section n at which the upper limit value (EVDMAX) is reached, and sets a distance from the current location to this point as the predetermined distance. The mode display unit 111c then displays the travel modes planned by the mode planning unit 111a within a range extending from the current location to the point located the predetermined distance ahead of the current location on the display apparatus 123 and the meter.

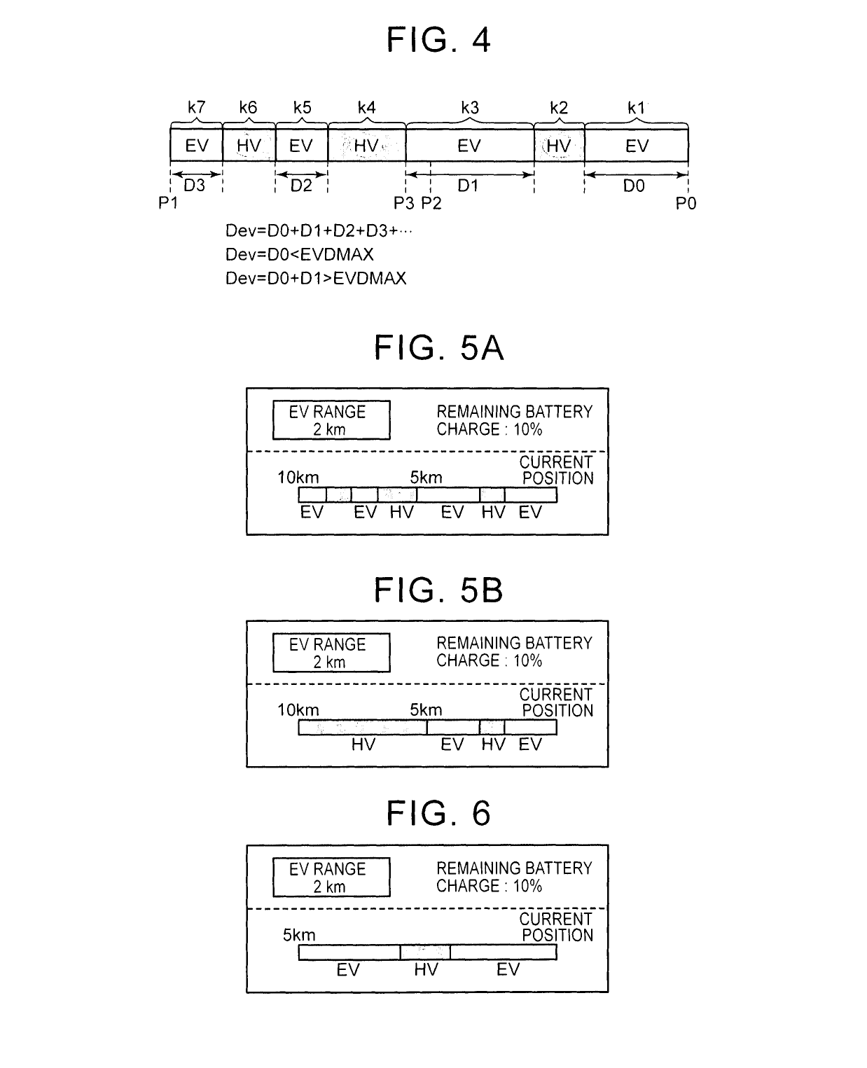

Next, referring to FIGS. 4, 5A, and 5B, a specific example of travel mode planning and display will be described. As shown in FIG. 4, for example, on a travel route retrieved by the navigation system 120 as a travel route from a current location before the start of travel to a destination, seven sections, namely a first section k1 to a seventh section k7, exist from a current position P0 up to a first position P1 located the predetermined distance ahead of the current position P0. When the travel route is set, a travel mode is planned by the mode planning unit 111a of the driving assistance unit 111 in each of the first section k1 to the seventh section k7. Here, the EV mode is planned as the travel mode in the first section k1, a third section k3, a fifth section k5, and the seventh section k7, and the HV mode is planned as the travel mode in a second section k2, a fourth section k4, and a sixth section k6.

FIG. 5A is a view showing a condition in which the travel modes of the travel route shown in FIG. 4 are displayed on the display apparatus 123 and the meter up to a point located 10 km ahead of the current position P0, where 10 km serves as the predetermined distance.

When the EV range is 2 km, for example, the upper limit value (EVDMAX) is set at 2 km+α. As shown in FIG. 4, the sum of the distances of the EV planned sections up to the first section k1 does not exceed the upper limit value (EVDMAX), but the sum of the distances of the EV planned sections up to the third section k3 exceeds the upper limit value (EVDMAX). In this case, the mode display unit 111c determines a second position P2 within the third section k3 at which the upper limit value (EVDMAX) is reached as the point located the predetermined distance ahead of the current position. In this embodiment, the second position P2 is a point located 5 km ahead of the current position P0. Accordingly, as shown in FIG. 5B, the mode display unit 111c displays the travel modes planned by the mode planning unit 111a up to a point located 5 km ahead of the current position P0, where 5 km serves as the predetermined distance. Further, from 5 km to 10 km, i.e. in all of the remaining sections, the mode display unit 111c displays the HV mode, which is different to the travel modes planned by the mode planning unit 111a.

In other words, the point located the predetermined distance ahead of the current location is determined so as not to exceed the upper limit value (EVDMAX) set on the basis of the predicted distance (EVD), i.e. the distance that can be traveled in the EV mode with the current remaining charge of the battery 113, and the planned travel modes are displayed from the current location up to the predetermined distance ahead of the current location. Hence, divergence from the predicted distance (EVD) can be apparently reduced, and as a result, a sense of discomfort experienced by the driver when the travel mode plan is displayed can be suppressed.

According to this embodiment, as described above, following effects can be obtained. (1) By modifying the displayed predetermined distance in accordance with the amount of power stored in the battery 113 at a given time, the display range of the planned travel modes is modified in accordance with the modification of the predetermined distance. In other words, by modifying the display range of the display modes, divergence from the predicted distance information can be apparently reduced, and as a result, a sense of discomfort experienced by the driver when the travel mode plan is displayed can be suppressed.

(2) The predicted distance (EVD) that can be traveled by the vehicle 100 in the EV mode is determined from the amount of power stored in the battery 113 at a given time, and the displayed predetermined distance is determined on the basis of the determined predicted distance (EVD). As a result, the sense of discomfort experienced when the planned travel modes are displayed is further lightened.

(3) More specifically, the displayed predetermined distance is determined in consideration of both the total distance (Dev) of the EV planned sections, among the sections from the current location up to the point located the predetermined distance ahead of the current location, and the upper limit value (EVDMAX) set on the basis of the predicted distance (EVD). Therefore, the precision of the predicted distance (EVD) is improved such that the difference thereof relative to the display range is further suppressed.

Note that the embodiment described above may be modified appropriately and implemented as follows. In the above embodiment, the margin α used to calculate the upper limit value (EVDMAX) is set at a value determined in accordance with the amount of power stored in the battery 113 at a given time. However, the margin α may be set at a fixed value regardless of the amount of power stored in the battery 113.

In the above embodiment, the upper limit value (EVDMAX) is calculated by adding the margin α to the predicted distance (EVD). As shown below in Equation (2), however, the upper limit value (EVDMAX) may be calculated by multiplying a margin β by the predicted distance (EVD). The margin β is used to close the gap between the predicted distance (EVD) and the actual traveled distance.

EVDMAX=EVD×β (2)

Further, as shown below in Equation (3), the upper limit value (EVDMAX) may be calculated by multiplying the margin β by the predicted distance (EVD) and adding the margin α thereto.

EVDMAX=EVD×β+α (3)

In the above embodiment, as shown in FIG. 5 B, within the preset distance of 10 km, the planned travel modes are displayed up to the point located the predetermined distance of 5 km ahead of the current location, and the HV mode is displayed from the point located the predetermined distance of 5 km ahead of the current location onward. As shown in FIG. 6, however, a range extending to a point on the travel route located the predetermined distance of 5 km ahead of the current position P0 may be displayed on the display apparatus 123 and the meter, and the planned travel modes may be displayed up to the point located the predetermined distance of 5 km ahead of the current position P0. In other words, the display scale may be modified from 10 km to the predetermined distance of 5 km. In so doing, similarly to the embodiment described above, divergence from the predicted distance (EVD) can be apparently reduced, and as a result, the sense of discomfort experienced by the driver when the travel mode plan is displayed can be suppressed.

In the above embodiment, as shown in FIG. 4, the predetermined distance to be displayed is set using the second position P2, which is the point within the EV planned section n including the upper limit value (EVDMAX) at which the upper limit value (EVDMAX) is reached, as the point located the predetermined distance ahead of the current location. However, the predetermined distance to be displayed may be determined using a third position P3, which is the end position of the EV planned section n including the upper limit value (EVDMAX), as the point located the predetermined distance ahead of the current location. In so doing, the displayed range can be determined in accordance with the sections.

In the above embodiment, the predetermined distance to be displayed is determined such that the total distance of the EV planned sections does not exceed the upper limit value (EVDMAX) set on the basis of the predicted distance (EVD). Instead of determining the upper limit value (EVDMAX) from the predicted distance (EVD), however, the predetermined distance to be displayed may be determined directly from the predicted distance (EVD).

Further, instead of determining the predetermined distance from the predicted distance (EVD), the predetermined distance to be displayed may be determined directly from the amount of power stored in the battery 113 at a given time. In the above embodiment, the mode display unit 111c doubles as the predicted distance calculation unit that calculates the predicted distance at which travel is possible in the EV mode from the amount of power stored in the battery 113. However, the predicted distance calculation unit may be configured differently to the mode display unit 111c.

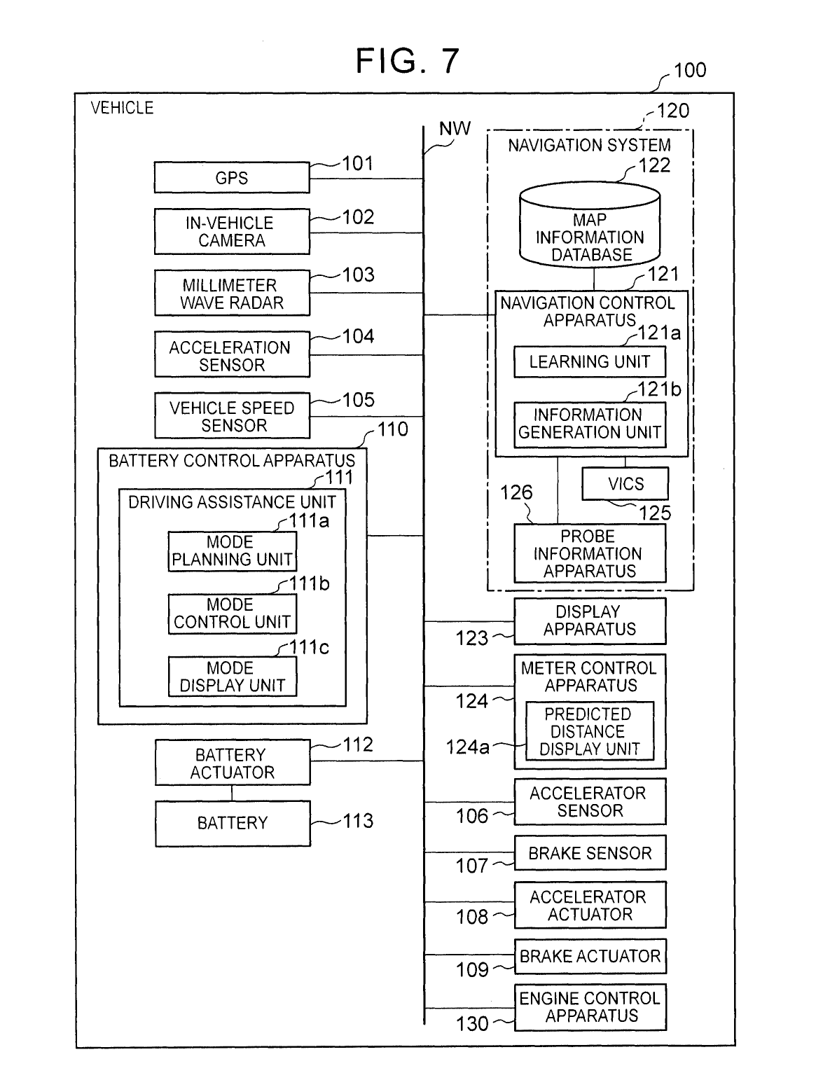

In the above embodiment, the mode display unit 111c calculates the predicted distance (EVD) and determines the predetermined distance within which the planned travel modes are to be displayed, but instead, calculation of the predicted distance (EVD) and determination of the predicted distance may be performed in different control apparatuses. As shown in FIG. 7, for example, a predicted distance display unit 124a of the meter control apparatus 124 may calculate the predicted distance (EVD) and display the calculated predicted distance (EVD) on the display apparatus 123 and the meter, while the mode display unit 111c of the hybrid control apparatus 110 determines the predetermined distance and displays the planned travel modes on the display apparatus 123 and the meter.

In the above embodiment, either one of the display apparatus 123 and the meter that display the travel modes may be omitted or changed appropriately to another display apparatus. In the above embodiment, a case in which the in-vehicle network NW is a CAN was described. The in-vehicle network NW is not limited thereto, however, and as long as the ECUs and the like connected thereto can be connected communicably, the in-vehicle network NW may be constituted by another network such as Ethernet (registered trademark), FlexRay (registered trademark), or IEEE 1394 (FireWire (registered trademark)). Moreover, these networks, including a CAN, may be combined. In so doing, the vehicle in which the movement assistance apparatus is used can be configured more freely.

In the above embodiment, the GPS 101 is connected to the navigation control apparatus 121 via the in-vehicle network NW, but the GPS 101 may be connected directly to the navigation control apparatus 121. In the above embodiment, a case in which the navigation system 120 and the driving assistance unit 111 are configured separately was described. The invention is not limited thereto, however, and the navigation system and the driving assistance unit may be provided in a single apparatus. In so doing, the movement assistance apparatus can be configured more freely.

In the above embodiment, a case in which the hybrid control apparatus 110 and the driving assistance unit 111 are provided in a single apparatus was described. The invention is not limited thereto, however, and the hybrid control apparatus and the driving assistance unit may be provided in separate apparatuses. In so doing, the movement assistance apparatus can be configured more freely.

In the above embodiment, a case in which the navigation system 120 and the respective apparatuses such as the display apparatus 123 are provided integrally in the vehicle 100 was described. The invention is not limited thereto, however, and as long as the navigation system and the respective apparatuses such as the display apparatus are connected to each other communicably, a portable information processing apparatus such as a portable telephone or a smart phone may be used for all or a part of the functions thereof. As a result, the design freedom of movement assistance apparatus is increased.

In the above embodiment, a case in which the driving assistance unit 111, the navigation system 120, the map information database 122, and so on are installed in the vehicle 100 was described. The invention is not limited thereto, however, and some of the functions of the driving assistance unit, the navigation system, the map information database, and so on may be provided in an information processing apparatus on the exterior of the vehicle or in a portable information processing apparatus. An information processing center may be cited as an example of an information processing apparatus on the exterior of the vehicle, and a portable telephone, a smart phone, and so on may be cited as examples of portable information processing apparatuses. In the case of an information processing apparatus on the exterior of the vehicle, information may be exchanged via a wireless communication line or the like. A portable information processing apparatus may be connected to the in-vehicle network, or connected by short-range communication, or may exchange information via a wireless communication line. As a result, the design freedom of the movement assistance apparatus is increased.

In the above embodiment, the learning unit 121a is provided to learn the movement time, the movement speed, the fuel consumption, and the power consumption on the traveled travel route obtained from the vehicle 100. However, a learning function for performing learning on the traveled travel route may be omitted. In so doing, the processing required for learning can be eliminated.

In the above embodiment, a case in which travel mode allocation is performed by the driving assistance unit 111 was described. The invention is not limited thereto, however, and travel mode allocation may be performed by the navigation control apparatus or the like. As a result, the design freedom of the movement assistance apparatus is increased.

In the above embodiment, a case in which travel mode allocation is executed mainly using the current location of the vehicle 100 as the departure place was described. However, travel mode allocation may be executed using any location of the vehicle moving toward the destination as the departure place. Regardless of the execution location, travel mode allocation can be performed appropriately in relation to all of the sections on the travel route. As a result, the design freedom of the movement assistance apparatus is increased.

Travel mode planning in the respective sections of the travel route is preferably performed in accordance with the travel load of each section, as in the above embodiment, but the travel mode planning method is not limited to this method. Instead, for example, travel mode planning may be performed in accordance with the vehicle speed, the time, and so on of each section.

1. A movement assistance apparatus that assists movement of a vehicle having an internal combustion engine and a motor as drive sources from a departure place to a destination, the movement assistance apparatus comprising:
a planning unit that plans one of a first travel mode in which an amount of power stored in a battery is not maintained and a second travel mode in which the amount of power stored in the battery is maintained in relation to respective sections marked out on a travel route from the departure place to the destination;
a predicted distance calculation unit that calculates a predicted distance over which the vehicle can travel in the first travel mode, from the amount of power stored in the battery; and
a display unit that displays set travel modes from a current location up to a point on the travel route located a predetermined distance ahead of the current location,
wherein the display unit displays the predicted distance, and determines the predetermined distance to be displayed on the basis of the predicted distance.

2. The movement assistance apparatus according to claim 1, wherein the display unit determines the predetermined distance to be displayed such that a total distance of sections in which the first travel mode is planned, from among sections from the current location up to the point located the predetermined distance ahead of the current location, does not exceed an upper limit value set on the basis of the predicted distance.

3. The movement assistance apparatus according to claim 1, wherein the display unit displays the travel modes planned by the planning unit within a range extending from the current location to the point located the predetermined distance ahead of the current location, from a display range in which the travel modes are displayed.

4. The movement assistance apparatus according to claim 1, wherein the display unit displays the travel modes planned by the planning unit after aligning a display range in which the travel modes are to be displayed with a range extending from the current location to the point located the predetermined distance ahead of the current location.

5. A movement assistance method for assisting movement of a vehicle having an internal combustion engine and a motor as drive sources from a departure place to a destination, the movement assistance method comprising:
causing a planning unit to plan one of a first travel mode in which an amount of power stored in a battery is not maintained and a second travel mode in which the amount of power stored in the battery is maintained in relation to respective sections marked out on a travel route from the departure place to the destination;
causing a predicted distance calculation unit to calculate a predicted distance over which the vehicle can travel in the first travel mode from the amount of power stored in the battery; and
causing a display unit to display the planned travel modes from a current location up to a point on the travel route located a predetermined distance ahead of the current location, wherein the display unit displays the predicted distance and determines the predetermined distance to be displayed on the basis of the predicted distance.

6. The movement assistance method according to claim 5, wherein the display unit determines the predetermined distance to be displayed such that a total distance of sections in which the first travel mode is planned, from among sections from the current location up to the point located the predetermined distance ahead of the current location, does not exceed an upper limit value set on the basis of the predicted distance.

7. The movement assistance method according to claim 5, wherein the display unit displays the travel modes planned by the planning unit within a range extending from the current location to the point located the predetermined distance ahead of the current location, from a display range in which the travel modes are displayed.

8. The movement assistance method according to claim 5, wherein the display unit displays the travel modes planned by the planning unit after aligning a display range in which the travel modes are to be displayed with a range extending from the current location to the point located the predetermined distance ahead of the current location.

9. A driving assistance system that assists driving of a vehicle having an internal combustion engine and a motor as drive sources on the basis of one travel mode selected from a plurality of different travel modes that are planned in respective sections marked out on a travel route of the vehicle from a departure place to a destination, the driving assistance system comprising the movement assistance apparatus according to claim 1, which plans and displays one travel mode selected from the plurality of travel modes in each section of the travel route.
